(19) United States
(12) Patent Application Publication
(10) Pub. No.: US 2021/0003757 A1
(43) Pub. Date: Jan. 7, 2021

(54) MULTILAYER LAMINATED FILM

(71) Applicant: TOYOBO FILM SOLUTIONS LIMITED, Tokyo (JP)

(72) Inventors: Dai NAKAGAWA, Tokyo (JP); Nobuyuki NAKANISHI, Tokyo (JP); Mitsuo TOJO, Tokyo (JP)

(73) Assignee: TOYOBO FILM SOLUTIONS LIMITED, Tokyo (JP)

(21) Appl. No.: 16/971,410

(22) PCT Filed: Feb. 21, 2019
(86) PCT No.: PCT/JP2019/006558

§ 371 Date: Aug. 20, 2020

(30) Foreign Application Priority Data
Feb. 22, 2018 (JP) 2018-029797

(51) Int. Cl. G02B 5/30; B32B 27/08; B32B 27/36; B32B 7/023

(52) U.S. Cl. CPC G02B 5/305; B32B 27/08; B32B 27/36; B32B 7/023; B32B 2457/202; B32B 2250/244; B32B 2307/416; B32B 2307/42; B32B 2250/05

(57) ABSTRACT

The invention provides a multilayer laminated film in which a birefringent layer comprising a first resin and an isotropic layer comprising a second resin are alternately laminated. The multilayer laminated film reflects light at a wavelength of 380-780 nm. A series of the birefringent layers has an optical thickness monotonically increasing region in which the 0.8×m^{th} layer has an optical thickness of 140-180 nm, wherein the first and m^{th} layers are the thinnest and thickest layers with optical thicknesses of 100 nm or more and 190 nm or less, respectively. A series of the isotropic layers has an optical thickness monotonically increasing region in which the 0.8×n^{th} layer has an optical thickness of 150-280 nm, wherein the first and n^{th} layers are the thinnest and thickest layers with optical thicknesses of 120 nm or more and 350 nm or less, respectively.

### TECHNICAL FIELD

The present disclosure relates to a multilayer laminated film that can widely reflect light in a visible light region.

### BACKGROUND ART

A multilayer laminated film in which many layers with a low refractive index and many layers with a high refractive index are alternately laminated can be used as an optical interference film that selectively reflects or transmits light with a specific wavelength due to optical interference caused from the layered structure. Further, by gradually changing the film thickness of each layer along the thickness direction, or by bonding together films having different reflection peaks, such a multilayer laminated film can reflect or transmit light in a wide wavelength range; attain a reflectance as high as a film using metal; and be used as a metallic luster film or a reflective mirror. Further, it is known that by stretching such a multilayer laminated film in one direction, the multilayer laminated film can also be used as a reflective polarizing film that reflects only a specific polarization component; and be used, for example, as a brightness-improving member for liquid crystal displays or the like (Patent Literature (PTL) 1 to Patent Literature (PTL) 4, etc.).

These multilayer laminated films are often required to have a higher reflectance in an arbitrary wavelength range. However, since the number of layers that can be laminated is limited, it is very difficult to achieve a high reflectance over a broad reflection wavelength range. In addition, increasing only the reflectance of light in a specific wavelength range might lead to a decrease in reflectance of light in other reflection wavelength ranges, causing an optical quality problem.

### CITATION LIST

### Patent Literature

PTL 1: JPH04-268505A

PTL 2: JPH09-506837A

PTL 3: JPH09-506984A

PTL 4: WO01/47711

### SUMMARY OF INVENTION

### Technical Problem

The present inventors found and focused on the fact that when a multilayer laminated film has uneven thickness, color unevenness that is striped, mottled, or the like occurs more significantly when viewed from an oblique direction, although such color unevenness is difficult to visually recognize when viewed at normal incidence. The inventors found that this is particularly likely to occur in an uniaxially stretched multilayer laminated film, such as a film for use in a reflective polarizing film; and that striped unevenness like bands in the stretching direction tends to occur in a uniaxially stretched film, whereas mottled unevenness tends to occur in a biaxially stretched film. In order to reduce such color unevenness recognized when viewed from the oblique direction, it is conceivable to extend the reflection band to a longer wavelength side. However, this leads to a decrease in reflection intensity of a specific reflection wavelength, as described above. It is ideal to eliminate the uneven thickness. However, when the resin or film-forming conditions for obtaining even thickness are selected, it is difficult to obtain the required optical properties, such as a high degree of polarization and reflectance.

Accordingly, an object of one embodiment of the present invention is to provide a multilayer laminated film that has a high reflectance, and whose color unevenness due to uneven thickness is difficult to visually recognize even when the film has some degree of uneven thickness.

### Solution to Problem

The present invention includes the following embodiments.
1. A multilayer laminated film comprising a multilayer laminate in which a birefringent layer comprising a first resin and an isotropic layer comprising a second resin are alternately laminated,

the multilayer laminated film being capable of reflecting light at a wavelength of 380 to 780 nm due to optical interference caused from the lamination structure of the birefringent layer and the isotropic layer,

a series of the birefringent layers having an optical thickness monotonically increasing region (first monotonically increasing region), wherein when the thinnest layer that has an optical thickness of 100 nm or more in the first monotonically increasing region is defined as the 1^{st} layer and the thickest layer that has an optical thickness of 190 nm or less in the first monotonically increasing region is defined as an m^{th} layer, the 0.8×m^{th} layer (if 0.8×m is not an integer, the ordinal of the rounded-off integer of 0.8×m) has an optical thickness in the range of 140 to 180 nm,

a series of the isotropic layers having an optical thickness monotonically increasing region (second monotonically increasing region), wherein when the thinnest layer that has an optical thickness of 120 nm or more in the second monotonically increasing region is defined as the 1^{st} layer and the thickest layer that has an optical thickness of 350 nm or less in the second monotonically increasing region is defined as an n^{th} layer, the 0.8×n^{th} layer (if 0.8×n is not an integer, the ordinal of the rounded-off integer of 0.8×n) has an optical thickness in the range of 150 to 280 nm.
2. A luminance-improving member comprising the multilayer laminated film of Item 1.
3. A polarizer for a liquid crystal display, the polarizer comprising the multilayer laminated film of item 1.

### Advantageous Effects of Invention

According to one embodiment of the present invention, a multilayer laminated film that has a high reflectance with less color unevenness caused by uneven thickness can be provided.

### BRIEF DESCRIPTION OF DRAWINGS

FIG. 1 is a schematic view showing an example of a layer thickness profile of the birefringent layers according to the present invention.

FIG. 2 is a schematic view showing an example of a layer thickness profile of the isotropic layers according to the present invention.

### DESCRIPTION OF EMBODIMENTS

An embodiment, which is an example of the present invention, is described below. The present invention is in no way limited to the following embodiment, and can be implemented with appropriate modifications within the scope of the present invention.

In the present specification, a numerical range indicated by “. . . to . . . ” means a range including the numerical values described before and after “to” as the lower limit and the upper limit.

### Multilayer Laminated Film

The multilayer laminated film according to one embodiment of the present invention comprises a multilayer laminate in which a birefringent layer comprising a first resin and an isotropic layer comprising a second resin are alternately laminated; can reflect light in a broad wavelength range of 380 to 780 nm in a visible light region due to optical interference caused by the lamination of the birefringent layers and the isotropic layers. The film can reflect light, for example, in a wavelength range of 400 to 760 nm, and preferably a wavelength range of 380 to 780 nm. In the present disclosure, the phrase “can reflect” or “capable of reflecting” means that in at least one arbitrary direction on the film surface, the average reflectance at perpendicular incidence of polarized light parallel to the direction is 50% or more. This reflection, in terms of the average reflectance in each wavelength range, can be 50% or more, and is preferably 60% or more, and more preferably 70% or more. When the film is used for optics, such as luminance-improving members, the average reflectance is preferably 85% or more, more preferably 86% or more, and even more preferably 88% or more.

In the present disclosure, the average reflectance is a value obtained by subtracting from 100 the average transmittance at the wavelength of 380 to 780 nm, which is determined using a polarizing film measurement apparatus (“VAP7070S,” manufactured by JASCO Corporation).

In the present disclosure, “composed mainly of a resin” means that the resin in each layer accounts for 70 mass % or more, preferably 80 mass % or more, and more preferably 90 mass % or more, of the total mass of each layer.

In order to achieve such reflection properties, the multilayer laminate of alternating layers preferably has a structure in which a birefringent layer and an isotropic layer are alternately laminated in the thickness direction so that the total number of the birefringent layers and the isotropic layers laminated is 30 or more; each birefringent layer being composed mainly of a first resin and having a film thickness of 10 to 1000 nm, and each isotropic layer being composed mainly of a second resin and having a film thickness of 10 to 1000 nm. The resin that forms the birefringent layers and the resin that forms the isotropic layers, which will be described in detail below, are not particularly limited as long as they can form a layer having birefringent properties and a layer having isotropic properties, respectively. Both of the resins are preferably thermoplastic resin from the viewpoint of easy production of the film. In the present disclosure, with respect to refractive indexes in the machine direction, the traverse direction, and the thickness direction, a layer having a reflective index difference of 0.1 or more between the maximum and the minimum is defined as being birefringent; and a layer having a reflective index difference of less than 0.1 is defined as being isotropic.

### Uneven Thickness

In the present disclosure, R value (%), which indicates uneven thickness, is represented by the following Formula 1.

$$R value ( \% ) = \frac{{R}_{max} - {R}_{min}}{{R}_{a v e}} \times 100 \qquad ( Formula 1 )$$

In Formula 1, Rₘₐₓ and Rₘᵢₙ respectively represent the maximum value and the minimum value of the thickness of the film at a measurement length of five meters with respect to the axial direction (which may be referred to as the machine direction, the longitudinal direction, or MD) of the film-forming machine. Rₐᵥₑ means the average value of the thickness of the film with respect to the axial direction of film-forming machine.

The multilayer laminated film of one embodiment according to the invention has an uneven thickness of, for example, 0.5% or more in terms of R value. For the purpose of reducing color unevenness, there is preferably no uneven thickness; however, it is in actuality very difficult to eliminate uneven thickness. Under such circumstances, according to one embodiment of the present invention, even when the film has some degree of uneven thickness, the effect of reducing the color unevenness is exhibited. According to one embodiment of the present invention, even when the R value of the uneven thickness is, for example, 1.0% or more or 1.5% or more, the color unevenness can be reduced.

### Layer Thickness Profile

The multilayer laminated film according to one embodiment of the invention can reflect light in a wide wavelength range by having the laminated structure of birefringent layers and isotropic layers with various optical thicknesses. This is because the reflection wavelength is attributed to the optical thickness of each layer that constitutes the multilayer laminated film. In general, the reflection wavelength of the multilayer laminated film is represented by the following Formula 2.

λ=2(n1×d1+n2×d2) (Formula 2)

(In Formula 2, λ represents a reflection wavelength (nm); n1 and n2 represent the refractive index of the birefringent layer and the refractive index of the isotropic layer, respectively; and d1 and d2 represent the physical thickness (nm) of the birefringent layer and the physical thickness (nm) of the isotropic layer, respectively.)

Further, an optical thickness λm (nm) is represented by the product of a refractive index nk and a physical thickness dk of each layer as in the following Formula 3. For the physical thickness, one obtained from a photograph taken with a transmission electron microscope can be employed.

λM (nm)=nk×dk (Formula 3)

In view of the above, it is possible to obtain a layer thickness profile with which light can be widely reflected at a wavelength of from 380 to 780 nm. For example, the multilayer laminated film can be designed to reflect light in a wide wavelength range by widening the thickness range in the monotonously increasing region described below; or can be designed to reflect light in a specific wavelength range in the monotonously increasing region, and reflect light outside the specific wavelength range in other regions to thereby reflect light in a broad wavelength range as a whole.

In one embodiment of the present invention, color unevenness can be reduced by setting the layer thickness profiles of the birefringent layers and the isotropic layers to a specific mode.

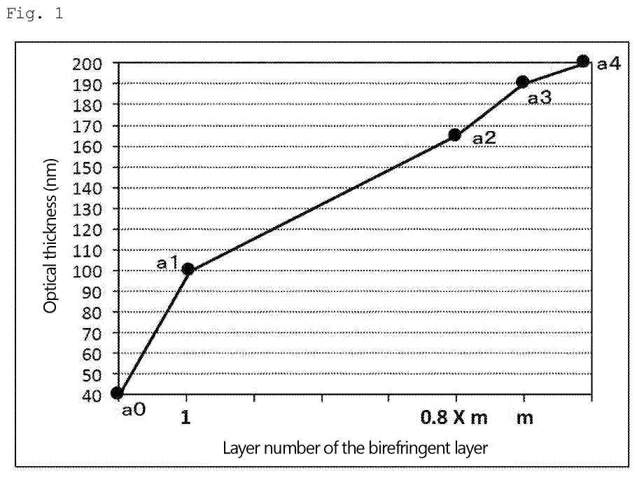

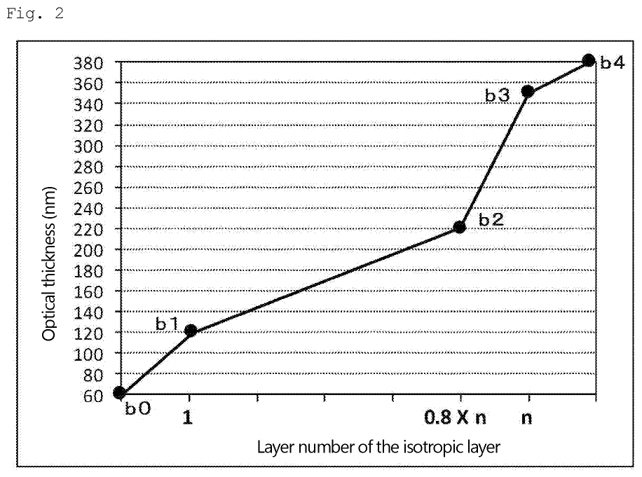

That is, the layer thickness profile of the birefringent layers in terms of optical thickness has a first monotonically increasing region. In the first monotonically increasing region, when the thinnest layer that has an optical thickness of 100 nm or more is defined as the 1^{st} layer and the thickest layer that has an optical thickness of 190 nm or less is defined as an m^{th} layer, the 0.8×m^{th} layer (if 0.8×m is not an integer, the ordinal of the rounded-off integer of 0.8×m) has an optical thickness in the range of 140 to 180 nm. The layer thickness profile of the isotropic layers in terms of optical thickness has a second monotonically increasing region. In the second monotonically increasing region, when the thinnest layer that has an optical thickness of 120 nm or more is defined as the 1^{st} layer and the thickest layer that has an optical thickness of 350 nm or less is defined as an n^{th} layer, the 0.8×n^{th} layer (if 0.8×n is not an integer, the ordinal of the rounded-off integer of 0.8×n) has an optical thickness in the range of 150 to 280 nm. FIGS. 1 and 2 are schematic diagrams of an example of layer thickness profiles according to the present invention.

FIG. 1 shows an example of a layer thickness profile of the birefringent layers. In this case, the layer thickness profile of the birefringent layers has a first monotonically increasing region from a0 to a4. In the first monotonically increasing region, a1 is the thinnest layer having an optical thickness of 100 nm or more, which is defined as the 1^{st} layer; a3 is the thickest layer having an optical thickness of 190 nm or less, which is defined as an m^{th} layer; and the thickness of the 0.8×m^{th} layer, which is represented by a2, is in the range of 140 to 180 nm. That is, FIG. 1 shows an embodiment in which the thickness of a2 does not significantly deviate from the straight line connecting a1 and a3.

FIG. 2 shows an example of a layer thickness profile of the isotropic layers. In this case, the layer thickness profile of the isotropic layers has a second monotonically increasing region from b0 to b4. In the second monotonically increasing region, b1 is the thinnest layer having an optical thickness of 120 nm or more, which is defined as the 1^{st} layer; b3 is the thickest layer having an optical thickness of 350 nm or less, which is defined as an n^{th} layer; and the thickness of the 0.8×n^{th} layer, which is represented by b2, is in the range of 150 to 280 nm. That is, FIG. 2 shows an embodiment in which the thickness of b2 deviates from the straight line connecting b1 and b3.

According to one embodiment of the present invention, the birefringent layers and the isotropic layers have the layer thickness profiles as described above, thereby providing an effect of rendering color unevenness due to uneven thickness less recognizable.

When all of the above requirements regarding the optical thickness are satisfied, a film having a high reflectance with less color unevenness in a striped, mottled, or like pattern can be provided. This is because when all of the above-stated optical thicknesses are satisfied, an appropriate distribution balance between layers in the range of thin optical thickness and layers in the range of thick optical thickness is achieved. This makes it possible to increase the reflection intensity in the desired wavelength range by utilizing higher-order reflection, such as secondary reflection or tertiary reflection, while widening the reflection wavelength range; thus achieving a multilayer laminated film with a higher reflectance, while having a broader reflection wavelength range. Conventionally, the reflection wavelength range tends to be narrow when a high reflectance is achieved. In contrast, according to one embodiment of the present invention, since the reflection wavelength range is broad with a high reflectance, spectral fluctuation due to uneven thickness hardly occurs in the visible light region; that is, color unevenness due to uneven thickness is difficult to recognize visually.

From the above viewpoint, the optical thickness of the 0.8×m^{th} birefringent layer from the thinner side is preferably in the range of 145 to 175 nm, more preferably in the range of 148 to 172 nm, and even more preferably in the range of 150 to 170 nm. The optical thickness of the 0.8×n^{th} isotropic layer from the thinner side is preferably in the range of 180 to 280 nm, more preferably in the range of 200 to 275 nm, even more preferably in the range of 220 to 265 nm, and particularly preferably in the range of 225 to 260 nm.

In the first monotonically increasing region, the thinnest layer that has an optical thickness of 100 nm or more (the 1^{st} layer) preferably has an optical thickness of 100 to 120 nm, more preferably 100 to 115 nm, and even more preferably 100 to 110 nm; and the thickest layer that has an optical thickness of 190 nm or less (the m^{th} layer) preferably has an optical thickness of 150 to 190 nm, more preferably 160 to 190 nm, and even more preferably 170 to 190 nm. In the second monotonically increasing region, the thinnest layer that has an optical thickness of 120 nm or more (the 1^{st} layer) preferably has an optical thickness of 120 to 140 nm, more preferably 120 to 135 nm, and even more preferably 120 to 130 nm; and the thickest layer that has an optical thickness of 350 nm or less (the n^{th} layer) preferably has an optical thickness of 310 to 350 nm, more preferably 320 to 350 nm, and even more preferably 330 to 350 nm. Thus, the resulting film can advantageously reflect light in the wide wavelength range of 380 to 780 nm.

Such a layer thickness profile can be obtained, for example, by adjusting the comb teeth in the feed block.

In the first monotonically increasing region, the thinnest layer preferably has an optical thickness of 75 nm or less, more preferably 70 nm or less, and even more preferably 65 nm or less. Although the lower limit is not limited, the thickness is, for example, preferably 45 nm or more, more preferably 50 nm or more, and even more preferably 55 nm or more. In the second monotonically increasing region, the thinnest layer preferably has an optical thickness of 95 nm or less, more preferably 90 nm or less, and even more preferably 85 nm or less. Although the lower limit is not limited, the thickness is, for example, preferably 65 nm or more, more preferably 70 nm or more, and even more preferably 75 nm or more. In the first monotonically increasing region, the thickest layer preferably has an optical thickness of 195 nm or more, more preferably 200 nm or more, and even more preferably 205 nm or more. Although the upper limit is not limited, the optical thickness is, for example, preferably 225 nm or less, more preferably 220 nm or less, and even more preferably 215 nm or less. In the second monotonically increasing region, the thickest layer preferably has an optical thickness of 345 nm or more, more preferably 350 nm or more, and even more preferably 355 nm or more. Although the upper limit is not limited, the optical thickness is, for example, preferably 375 nm or less, more preferably 370 nm or less, and even more preferably 365 nm or less. According to the above embodiment, the resulting film can advantageously reflect light in the wide wavelength range of 380 to 780 nm.

In one embodiment of the present invention, the number of layers can be increased by doubling or the like, as described below. In such a case, it is only necessary to look at the layer thickness profile of one packet. When looking at the overall layer thickness profile of a multilayer laminated film, for example, if there are multiple portions having similar layer thickness profiles, each portion can be regarded as a packet; and multilayer structure portions separated by, for example, an intermediate layer, can be regarded as separate packets.

### Monotonically Increasing Region

In the present disclosure, “monotonically increasing” preferably means that in the entire multilayer laminate of alternating layers of the multilayer laminated film, a thicker-side layer is thicker than a thinner-side layer; however, this is not limitative. It is sufficient as long as there is a tendency for the thickness to increase from the thinner side to the thicker side as seen in the entire view. More specifically, when the layers are numbered from the thinner side to the thicker side in terms of optical thickness, and the film thickness of each layer is plotted on the ordinate with the layer number of each numbered layer being plotted on the abscissa, the layers within the range showing a tendency of increasing film thickness are equally divided into five. If the average value of the film thicknesses in each equally divided area monotonically increases in the direction in which the film thickness increases, the tendency is regarded as a monotonic increase; if this is not the case, the tendency is not regarded as a monotonic increase. Note that the birefringent layers and the isotropic layers can be viewed individually, and the monotonic increase of the birefringent layers and the monotonic increase of the isotropic layers may have different slopes. Moreover, the monotonic increase described above may be in an embodiment in which the thickness monotonically increases entirely from one outermost layer to the other outermost layer in the multilayer laminate of alternating layers. In some embodiments, the monotonously increasing thickness region may account for 80% or more, preferably 90% or more, and more preferably 95% or more, of the multilayer laminate of alternating layers in terms of the number of layers; and the thickness in the remaining portion may be constant, or decrease. For example, Example 1 according to the present disclosure is an embodiment in which the thickness monotonically increases in the 100% portion of the laminated multilayer structure. In some embodiments, the multilayer laminated film may include a region where the thickness does not monotonically increase at the smaller layer number side and/or the larger layer number side of the thickness profile described above.

### Structure of Multilayer Laminated Film Birefringent Layer

The birefringent layer of the multilayer laminated film according to one embodiment of the present invention has birefringent properties. That is, the resin that forms the birefringent layer (also referred to as the “first resin” in the present disclosure) is capable of forming birefringent layers. Accordingly, the resin that forms the birefringent layer is preferably an oriented crystalline resin, and the oriented crystalline resin is especially preferably a polyester. The polyester preferably contains ethylene terephthalate units and/or ethylene naphthalate units, more preferably ethylene naphthalate units, in an amount in the range of 80 mol % or more to 100 mol % or less, based on the repeating units constituting the polyester; this is because a layer having a higher refractive index can thereby be readily foamed, which makes it easy to increase the difference in refractive index between the birefringent layer and the isotropic layer. Here, in the case of the combined use of resins, the content is a total content.

### Polyester for Birefringent Layer

A preferred polyester for birefringent layers contains a naphthalenedicarboxylic acid component as a dicarboxylic acid component; and the content of the naphthalenedicarboxylic acid component is preferably 80 mol % or more and 100 mol % or less, based on the dicarboxylic acid component of the polyester. Examples of the naphthalenedicarboxylic acid component include a 2,6-naphthalenedicarboxylic acid component, a 2,7-naphthalenedicarboxylic acid component; components derived from a combination of these components; and derivative components thereof. Particularly preferred examples include a 2,6-naphthalenedicarboxylic acid component, and derivative components thereof. The content of the naphthalenedicarboxylic acid component is preferably 85 mol % or more, more preferably 90 mol % or more; and is preferably less than 100 mol %, more preferably 98 mol % or less, and even more preferably 95 mol % or less.

The polyester for birefringent layers may further contain a terephthalic acid component, an isophthalic acid component, or the like, especially preferably a terephthalic acid component, as a dicarboxylic acid component of the polyester for birefringent layers, in addition to the naphthalenedicarboxylic acid component as long as the object of the present invention is not impaired. The content of the additional dicarboxylic acid component is preferably in the range of more than 0 mol % and 20 mol % or less, more preferably 2 mol % or more, and even more preferably 5 mol % or more; and is more preferably 15 mol % or less, and even more preferably 10 mol % or less.

When the multilayer laminated film is used as a luminance-improving member or a reflective polarizer for use in a liquid crystal display or the like, it is preferred that the birefringent layers have relatively higher refractive index properties than the isotropic layers, that the isotropic layers have relatively lower refractive index properties than the birefringent layers, and that the film be stretched in a uniaxial direction. In this case, in the present disclosure, the uniaxially stretching direction may be referred to as the “X direction,” the direction orthogonal to the X direction on the film plane may be referred to as the “Y direction” (also referred to as the “non-stretching direction”), and the direction perpendicular to the film plane may be referred to as the “Z direction” (also referred to as the “thickness direction”).

When the birefringent layer comprises a polyester containing a naphthalenedicarboxylic acid component as the main component as described above, the birefringent layer can show a high refractive index in the X direction, and also simultaneously achieve high birefringence characteristics with high uniaxial orientation; this can increase the refractive index difference in the X direction between the birefringent layer and the isotropic layer, thus contributing to a high degree of polarization. In contrast, if the content of the naphthalenedicarboxylic acid component is less than the lower limit, amorphous properties tend to increase; and the difference between a refractive index in the X direction, nX, and a refractive index in the Y direction, nY, tends to decrease. Therefore, the multilayer laminated film is less likely to obtain satisfactory reflection performance of the P-polarized light component (in the present disclosure), which is defined as a polarized light component being parallel to the incidence plane including the uniaxially stretching direction (X direction), with the film surface being used as a reflection surface. In the multilayer laminated film, the S-polarized light component (in the present disclosure) is defined as a polarized light component being perpendicular to the incidence plane that includes the uniaxially stretching direction (X direction), with the film surface being used as a reflection surface.

As the diol component of a preferred polyester for birefringent layers, an ethylene glycol component is used. The content of the ethylene glycol component is preferably 80 mol % or more and 100 mol % or less, more preferably 85 mol % or more and 100 mol % or less; and even more preferably 90 mol % or more and 100 mol % or less, and particularly preferably 90 mol % or more and 98 mol % or less, based on the diol component of the polyester. If the amount of the diol component is less than the lower limit, the uniaxial orientation described above may be impaired.

The polyester for birefringent layers may further contain a trimethylene glycol component, a tetramethylene glycol component, a cyclohexanedimethanol component, a diethylene glycol component, or the like as a diol component of the polyester for birefringent layers, in addition to the ethylene glycol component, as long as the object of the present invention is not impaired.

### Properties of Polyester for Birefringent Layer

The melting point of the polyester for birefringent layers is preferably in the range of 220 to 290° C., more preferably 230 to 280° C., and even more preferably 240 to 270° C. The melting point can be determined by measurement using a differential scanning calorimeter (DSC). When the melting point of the polyester is more than the upper limit, fluidity is likely to be poor at the time of molding through melt extrusion, thus causing extrusion or the like to be non-uniform. On the other hand, if the melting point is less than the lower limit, excellent film formability is attained, but the mechanical properties etc. of the polyester are likely to worsen; additionally, it tends to be difficult for the film to exhibit the refractive index properties required when used as a luminance-improving member or a reflective polarizer for a liquid crystal display.

The glass transition temperature (hereinafter sometimes referred to as “Tg”) of the polyester used for birefringent layers is preferably in the range of 80 to 120° C., more preferably 82 to 118° C., even more preferably 85 to 118° C., and particularly preferably 100 to 115° C. When Tg is in this range, the resulting film has excellent heat resistance and dimensional stability, and readily exhibits the refractive index properties required when used as a luminance-improving member or a reflective polarizer for a liquid crystal display. The melting point and the glass transition temperature can be adjusted by controlling, for example, the type and amount of copolymer component, and diethylene glycol, which is a by-product.

The polyester used for birefringent layers preferably has an intrinsic viscosity of 0.50 to 0.75 dl/g, more preferably 0.55 to 0.72 dl/g, and even more preferably 0.56 to 0.71 dl/g, as measured at 35° C. using an o-chlorophenol solution. By having such an intrinsic viscosity, the birefringent layer tends to readily have appropriately oriented crystallinity, and a difference in the refractive index between the birefringent layer and the isotropic layer tends to easily increase.

### Isotropic Layer

The isotropic layer of the multilayer laminated film according to one embodiment of the present invention is a layer having isotropic properties. That is, the resin of the isotropic layer (also referred to as the “second resin” in the present disclosure) is capable of forming isotropic layers. Thus, the resin that forms the isotropic layer is preferably an amorphous resin. In particular, an amorphous polyester is preferred. The term “amorphous” as used herein does not exclude a resin having slight crystalline properties, but includes any resin that can make the layer isotropic to an extent that the multilayer laminated film according to the present disclosure can have the intended function.

### Copolyester for Isotropic Layer

The resin that forms the isotropic layers is preferably a copolyester. It is particularly preferable to use a copolyester containing a naphthalenedicarboxylic acid component, an ethylene glycol component, and a trimethylene glycol component as copolymer components. Examples of the naphthalenedicarboxylic acid component include a 2,6-naphthalenedicarboxylic acid component, a 2,7-naphthalenedicarboxylic acid component, components derived from a combination of these components, and derivative components thereof. Particularly preferred examples include a 2,6-naphthalenedicarboxylic acid component and derivative components thereof. The copolymer component as referred to therein means any of the components that constitute the polyester. The copolymer component is not limited to a copolymer component as a minor component (which is used in an amount for copolymerization of less than 50 mol %, based on the total amount of the acid component or the total amount of the diol component), and also includes a main component (which is a component used in an amount for copolymerization of 50 mol % or more, based on the total amount of the acid component or the total amount of the diol component).

In one embodiment of the present invention, a polyester having an ethylene naphthalate unit as a main component is preferably used as a resin for isotropic layers, as described above. This is preferable because the use of a copolyester containing a naphthalenedicarboxylic acid component as the resin for isotropic layers increases the compatibility with birefringent layers, and tends to improve interlayer adhesion to the birefringent layers, so that delamination is less likely to occur.

The copolyester for isotropic layers preferably contains at least two components, i.e., an ethylene glycol component and a trimethylene glycol component, as diol components. Of these, the ethylene glycol component is preferably used as the main diol component from the viewpoint of film formability etc.

The copolyester for isotropic layers in one embodiment of the present invention preferably further contains a trimethylene glycol component as a diol component. The presence of a trimethylene glycol component in the copolyester compensates for the elasticity of the layer structure to enhance the effect of suppressing delamination.

The naphthalenedicarboxylic acid component, preferably a 2,6-naphthalenedicarboxylic acid component, preferably accounts for 30 mol % or more and 100 mol % or less, more preferably 30 mol % or more and 80 mol % or less, and even more preferably 40 mol % or more and 70 mol % or less, of the entire carboxylic acid component of the copolyester for isotropic layers. Using this component in the above range can further increase the adhesion to the birefringent layer. If the content of the naphthalenedicarboxylic acid component is less than the lower limit, lower adhesion may result in view of compatibility. The upper limit of the content of the naphthalenedicarboxylic acid component is not particularly limited; however, if the amount is overly large, it tends to be difficult to increase a difference in refractive index between the birefringent layer and the isotropic layer. In order to adjust the relationship between the refractive index of the birefringent layer and the refractive index of the isotropic layer, other dicarboxylic acid components may also be copolymerized.

The amount of the ethylene glycol component is preferably 50 mol %or more and 95 mol % or less, more preferably 50 mol % or more and 90 mol % or less, even more preferably 50 mol % or more and 85 mol % or less, and particularly preferably 50 mol % or more and 80 mol % or less of the entire diol component of the copolyester for isotropic layers. By using this component in the above range, a difference in refractive index between the birefringent layer and the isotropic layer tends to easily increase.

The amount of the trimethylene glycol component is preferably 3 mol % or more and 50 mol % or less, more preferably 5 mol % or more and 40 mol % or less, even more preferably 10 mol % or more and 40 mol % or less, and particularly preferably 10 mol % or more and 30 mol % or less, of the entire diol component of the copolyester for isotropic layers. Using this component in the above range can further increase the interlayer adhesion to the birefringent layer; furthermore, a difference in refractive index between the birefringent layer and the isotropic layer tends to easily increase. If the content of the trimethylene glycol component is less than the lower limit, ensuring the interlayer adhesion tends to be difficult. If the content of the trimethylene glycol component is more than the upper limit, it is difficult to obtain a resin having the desired refractive index and glass transition temperature.

The isotropic layer in one embodiment of the present invention may contain a thermoplastic resin other than the copolyester as an additional polymer component in an amount in the range of 10 mass % or less, based on the mass of the isotropic layer, as long as the object of the present invention is not impaired.

### Properties of Polyester for Isotropic Layer

In one embodiment of the present invention, the copolyester for isotropic layers described above preferably has a glass transition temperature of 85° C. or more, more preferably 90° C. or more and 150° C. or less, even more preferably 90° C. or more and 120° C. or less, and particularly preferably 93° C. or more and 110° C. or less. This provides more excellent heat resistance. In addition, a difference in refractive index between the birefringent layer and the isotropic layer tends to easily increase. If the glass transition temperature of the copolyester for isotropic layers is less than the lower limit, sufficient heat resistance may not be obtained. For example, when subjected to a process including a step of heat treatment at about 90° C. or the like, the isotropic layer is likely to suffer crystallization or embrittlement to increase the haze; accordingly, the resulting film may exhibit a lower degree of polarization when used as a luminance-improving member or a reflective polarizer. On the other hand, when the glass transition temperature of the copolyester for isotropic layers is overly high, stretching is also likely to impart birefringence to the polyester for isotropic layers due to stretching; accordingly, the difference in the refractive index in the stretching direction between the birefringent layer and the isotropic layer is reduced, thus causing the reflection performance to be poor.

Among the above-mentioned copolyesters, amorphous copolyesters are preferred from the viewpoint of extremely excellent suppression of haze increase caused by crystallization in a heat treatment at a temperature of 90° C. for 1000 hours. The term “amorphous” as used herein means that when the temperature is increased at a temperature increase rate of 20° C./minute in the measurement using a DSC, the heat of crystal fusion is less than 0.1 mJ/mg.

Specific examples of the copolyester for isotropic layers include (1) a copolyester containing a 2,6-naphthalenedicarboxylic acid component as a dicarboxylic acid component, and an ethylene glycol component and a trimethylene glycol component as diol components; and (2) a copolyester containing a 2,6-naphthalenedicarboxylic acid component and a terephthalic acid component as dicarboxylic acid components, and an ethylene glycol component and a trimethylene glycol component as diol components.

The copolyester for isotropic layers preferably has an intrinsic viscosity of 0.50 to 0.70 dl/g, more preferably 0.55 to 0.65 dl/g, as measured using an o-chlorophenol solution at 35° C. When the copolyester used for isotropic layers has a trimethylene glycol component as a copolymer component, the film-forming properties may be poor. The film-forming properties can be enhanced by using a copolyester having an intrinsic viscosity within the above-mentioned range. The intrinsic viscosity of the copolyester used as the isotropic layer is preferably higher from the viewpoint of film-forming properties; however, when the intrinsic viscosity is higher than the upper limit, the difference in melt viscosity between the polyester for birefringent layers and the polyester for isotropic layers increases, which may cause the thickness of the layers to be non-uniform.

### Other Layers

### Outermost Layer

The multilayer laminated film according to one embodiment of the present invention can comprise an outermost layer on one or both surfaces thereof. The outermost layer is composed mainly of a resin. Here, the phrase “composed mainly of a resin” means that a resin accounts for 70 mass % or more, preferably 80 mass % or more, and more preferably 90 mass % or more, of the total mass of the layer. The outermost layer is preferably an isotropic layer. The outermost layer may be composed of the same resin as that for isotropic layers from the viewpoint of easy production, and can be formed of the copolyester for isotropic layers; such an embodiment is preferred.

### Intermediate Layer

The multilayer laminated film according to one embodiment of the present invention may comprise one or more intermediate layers.

In the present disclosure, the intermediate layer may also be referred to as, for example, the “inner thick layer” and means a thick layer present inside of the alternately laminated structure of the birefringent layer and the isotropic layer. The term “thick” as used herein means that the film is optically thick. In the present disclosure, a method is preferably used in which a thick layer (which may be referred to as “thickness adjustment layer” or “buffer layer”) is formed on both sides of the alternately laminated structure in the initial stage of the production of the multilayer laminated film, and the number of layers laminated is then increased by doubling. When this method is used, two thick layers are laminated to form an intermediate layer; a thick layer formed inside is referred to as an “intermediate layer,” and a thick layer formed outside is referred to as an “outermost layer.”

The intermediate layer preferably has a layer thickness of, for example, 5 μm or more and 100 μm or less, and more preferably 50 μm or less. When such an intermediate layer is provided in part of the alternately laminated structure of the the birefringent layer and the isotropic layer, the thickness of the layers constituting the birefringent layers and the isotropic layers can be easily adjusted to be made uniform, without affecting the polarization function. The intermediate layer may have the same composition as the composition of the birefringent layers or the composition of the isotropic layers, or may have a composition that partially includes the composition of the birefringent layers or the composition of the isotropic layers. The intermediate layer is thick, and thus does not contribute to the reflection properties. On the other hand, the intermediate layer may affect the light transmission properties; therefore, when the layer contains particles, the particle diameter and the particle concentration can be selected in consideration of light transmittance.

If the thickness of the intermediate layer is less than the lower limit, the layer structure of the multilayer structure may be disordered, and the reflection performance may be reduced. On the other hand, if the thickness of the intermediate layer is more than the upper limit, the entire multilayer laminated film may be overly thick, which makes it difficult to save space when the film is used as a reflective polarizer or a luminance-improving member for a thin liquid crystal display. When the multilayer laminated film contains a plurality of intermediate layers, the thickness of each intermediate layer is preferably not less than the lower limit of the range of the thickness described above, and the total thickness of the intermediate layers is preferably not greater than the upper limit of the range of the thickness described above.

The polymer used for the intermediate layer may be a resin different from the resin for birefringent layers or the resin for isotropic layers, as long as the polymer can be incorporated into the multilayer structure by using the method for producing the multilayer laminated film according to the present disclosure. From the viewpoint of the interlayer adhesion, the resin preferably has the same composition as that of either the birefringent layer or the isotropic layer, or a composition partially including the composition of either the birefringent layer or the isotropic layer.

The method for forming the intermediate layer is not particularly limited. For example, a thick layer is provided on both sides of the alternately laminated structure before doubling, which is divided into two in the direction perpendicular to the alternately laminated direction by using a branch block called a layer doubling block; and the divided layers are laminated again in the alternately laminated direction, so that one intermediate layer can be provided. A plurality of intermediate layers can also be provided by dividing the alternately laminated structure into three or four by a similar technique.

### Coating Layer

The multilayer laminated film according to one embodiment of the present invention can have a coating layer on at least one surface of the film. Examples of such coating layers include a high-slipperiness layer for imparting slipperiness; a primer layer for imparting adhesion to a prism layer, a diffusion layer, etc.; and the like. The coating layer contains a binder component; and may contain, for example, particles, in order to impart slipperiness. To impart easy adhesion, for example, a binder component chemically close to the component of the layer to be adhered may be used. The coating liquid for forming the coating layer is preferably a water-based coating liquid using water as a solvent, from the environmental point of view; and particularly in such a case or other cases, for the purpose of improving wettability of the coating liquid onto the multilayer laminated film, the coating liquid can contain a surfactant. A functional agent may also be added; for example, a crosslinking agent may be added to improve the strength of the coating layer.

### Method for Producing Multilayer Laminated Film

The method for producing the multilayer laminated film according to one embodiment of the present invention is described below in detail. The production method described hereinbelow is an example, and the present invention is not limited thereto. Further, different embodiments of the film can be obtained with reference to the following method.

The multilayer laminated film according to one embodiment of the present invention can be obtained by the following method. After a polymer for forming birefringent layers and a polymer for forming isotropic layers are alternately laminated in a molten state using a multilayer feed block device to form an alternately laminated structure comprising, for example, 30 layers or more in total, a buffer layer is formed on both sides of the laminated structure. The alternately laminated structure having the buffer layers is then divided into, for example, two to four by using an apparatus called “layer doubling,” and the divided layers are laminated again with the alternately laminated structure having the buffer layers as one block; therefore, the number of laminated blocks (the number of doublings) becomes two- to four-fold, thereby increasing the number of laminated layers. According to this method, it is Possible to obtain a multilayer laminated film comprising an intermediate layer, which is formed of a laminate of two buffer layers, inside of the multilayer structure, and an outermost layer, which is composed of one buffer layer, on both sides of the multilayer structure.

This multilayer structure is formed by laminating the layers in such a manner that the thickness of the birefringent layers and the thickness of the isotropic layers each have a desired inclination in thickness profile. This can be achieved, for example, by changing the width or length of slits in a multilayer feed block device. For example, the birefringent layers and/or isotropic layers can have a different slope change rate in at least two optical thickness regions. Accordingly, in such a case, the width or length of the slits in the multilayer feed block may be adjusted so that the at least two optical thickness regions each have at least one or more inflection points.

After a desired number of layers are laminated by the method described above, the layers are extruded from a die and cooled on a casting drum to obtain a multilayer unstretched film. The multilayer unstretched film is preferably stretched in at least one axial direction (this one axial direction is along the film surface) selected from the axial direction of the film-forming machine (which may be referred to as “machine direction,” “longitudinal direction,” or “MD direction”), and the direction orthogonal thereto on the film surface (which may be referred to as “traverse direction,” “width direction”, or “TD”). The stretching temperature is preferably performed in the range of a glass transition temperature (Tg) of the polymer for birefringent layers to (Tg+20)° C. The orientation properties of the film can be more precisely controlled by stretching the film at a temperature lower than a conventional stretching temperature.

The stretch ratio is preferably from 2.0- to 7.0-fold, and more preferably from 4.5- to 6.5-fold. Within this range, the greater the stretch ratio, the smaller the variation in the refractive index in the surface direction of the individual layers of the birefringent layers and isotropic layers due to the thinning by the stretching; light interference of the multilayer laminated film becomes uniform in the surface direction; and the difference in refractive index between the birefringent layer and the isotropic layer in the stretching direction preferably increases. The stretching method used for this stretching can be a known stretching method, such as heat stretching using a rod heater, roll heat stretching, or tenter stretching. Tenter stretching is preferable from the viewpoint of, for example, reduction in scratches due to contact with a roller, and stretching speed.

When the film is also subjected to a stretching process in the direction orthogonal to the stretching direction on the film surface (Y-direction) to perform biaxial stretching, the stretch ratio is preferably as low as about 1.01- to 1.20-fold, in order to impart reflective polarization properties to the film; however, the desired stretch ratio varies depending on the purpose of use. If the stretching ratio in the Y-direction is further increased, the polarization performance may deteriorate.

Further, the orientation properties of the obtained multilayer laminated film can be more precisely controlled by toe-out (re-stretching) in the stretching direction in the range of 5 to 15% after stretching, while performing heat-setting at a temperature of Tg to (Tg+30)° C.

In one embodiment of the present invention, when the coated layer described above is provided, the application of the coating liquid to the multilayer laminated film can be performed at any stage, and is preferably performed during the film production process. The coating liquid is preferably applied to the film before stretching.

The multilayer laminated film according to one embodiment of the present invention is thus obtained.

When the multilayer laminated film is to be used for a metallic luster film or a reflective mirror, the film is preferably a biaxially stretched film. In this case, either a sequential biaxial stretching method or a simultaneous biaxial stretching method can be used. The stretch ratio may be adjusted so that the refractive index and the film thickness of the birefringent layers and those of isotropic layers provide the desired reflection properties. For example, in consideration of general refractive indexes of the resins forming these layers, the stretch ratio may be about 2.5- to 6.5-fold in both the machine direction and the traverse direction.

### EXAMPLES

Embodiments of the present invention are described below with reference to Examples; however, the present invention is not limited to the Examples shown below. The physical properties and characteristics in the Examples were measured or evaluated by the following methods.

### (1) Thickness of Each Layer

A multilayer laminated film was cut out to a size of 2 mm in the longitudinal direction of the film and 2 cm in the width direction, fixed to an embedding capsule, and then embedded in an epoxy resin (Epomount, manufactured by Refine Tec Ltd.). The embedded sample was cut perpendicularly to the width direction with a microtome (Ultracut-UCT, manufactured by Leica) to obtain a thin section with a thickness of 50 nm. The thin section of the film was observed and photographed at an accelerating voltage of 100 kV using a transmission electron microscope (Hitachi S-4300). The thickness (physical thickness) of each layer was measured from the photograph.

With respect to the layers having a thickness of more than 1 μm, a layer present inside the multilayer structure was regarded as an intermediate layer, and a layer present on the outermost surface layer of the multilayer structure was regarded as an outermost layer. The thickness of each of the layers was measured.

The optical thickness of the birefringent layers and that of isotropic layers were each calculated by substituting the physical thickness vale of each layer obtained above and the refractive index value of each layer calculated by the following (2) into the above Formula 3. For the birefringent layers, the thinnest layer having an optical thickness of 100 nm or more and the thickest layer having an optical thickness of 190 nm or less in the monotonically increasing region were specified. Each of the birefringent layers was numbered, and the 0.8×m^{th} layer (if 0.8×m is not an integer, the ordinal of the rounded-off integer of 0.8×m) was specified. Similarly, for the isotropic layers, the thinnest layer having an optical thickness of 120 nm or more and the thickest layer having an optical thickness of 350 nm or less in the monotonically increasing region were specified. Each of the isotropic layers was numbered, and the 0.8×n^{th} layer (if 0.8×n is not an integer, the ordinal of the rounded-off integer of 0.8×n) was specified.

Whether each layer is a birefringent layer or an isotropic layer can be determined based on the refractive index. When this is difficult to determine, it can be determined based on NMR analysis or the electronic state by TEM analysis.

### (2) Refractive Index After Stretching in Each Direction

The polyester for forming birefringent layers and the polyester for forming isotropic layers were individually melted and extruded through a die to individually prepare films cast on a casting drum. Then, the obtained films were stretched 5.9-fold in a uniaxial direction at 145° C. to prepare stretched films. For the cast films and the stretched films thus obtained, refractive indexes in the stretching direction (X-direction), the direction orthogonal thereto (Y-direction), and the thickness direction (Z-direction) (individually referred to as “nX”, “nY”, and “nZ”) were measured at a wavelength of 633 nm using a prism couple, and the obtained values were used as refractive indexes after stretching.

### (3) Determination of Monotonic Increase

In an arbitrary region of layer thickness profiles, which were individually prepared by imputing the optical thickness of the birefringent layers or the optical thickness of the isotropic layers on the ordinate and the layer number of each layer on the abscissa, the number of the layers of the birefringent layers or the isotropic layers within the range showing an increasing tendency in film thickness was equally divided into five. If the average value of the film thicknesses in each equally divided area monotonically increased in the direction in which the film thickness increased, the tendency was regarded as a monotonic increase; if this is not the case, the tendency was not regarded as a monotonic increase.

### (4) Uneven Thickness

Strip-shaped samples were prepared by cutting out each film to a width of about 30 mm and a length of about 6 m in the axial direction of the film-foaming machine. After the surface of each sample was wiped with alcohol and dust was removed, an electronic micrometer and a recorder (K-312A, K310B, manufactured by Anritsu Corporation) were used to travel on the film at 25 mm/s over a measurement length of 5 m, thus measuring the thickness at a pitch of 0.25 mm in the axial direction of the film-forming machine, and creating a graph. The maximum value, the minimum value, and the average value of the thickness in the obtained graph were defined as Rₘₐₓ, Rₘᵢₙ, and Rₐᵥₑ, respectively. The R value, which indicates uneven thickness, was calculated by subtracting Rₘᵢₙ from Rₘₐₓ and then dividing the obtained value by Rₐᵥₑ.

### (5) Color Unevenness Evaluation

In a state where a film cut into a 60-mm square was placed in a light box (LED Viewer Pro, FUJICOLOR) and a polarizer was placed on the film, the number of recognized uneven-color stripes parallel to the direction of the reflection axis was counted when the film was viewed obliquely at an angle of 60 degrees from the direction in which the transmission axis was horizontal. For the observation, the transmission axis of the polarizer was disposed parallel to the transmission axis of the film. The film was evaluated as A to E based on the number of uneven-color stripes.
A: No uneven-color stripes.
B: One uneven-color stripe was observed; however, the difference in color between the stripe part and the good part was small, with an ambiguous boundary therebetween.
C: One uneven-color stripe.
D: Two uneven-color stripes.
E: Three or more uneven-color stripes.

When the color unevenness was mottled, the film was evaluated as A to E based on to the number of recognized areas of uneven color having an area of at 1 cm² or more when the film was viewed obliquely at an angle of 60 degrees from an arbitrary direction.
A: No uneven-color mottling.
B: One area of uneven-color mottling was observed; however, the difference in color between the mottled area and the good part was small, with an ambiguous boundary therebetween.
C: One area of uneven-color mottling.
D: Two or three areas of uneven-color mottling.
E: Four or more areas of uneven-color mottling.

### (6) Average Transmittance

The transmission spectrum of the obtained multilayer laminated film was measured using a polarizing film measuring device (“VAP7070S”; produced by JASCO Corporation). For the measurement, a spot diameter adjusting mask Φ 1.4 and an angle-adjustable stage were used, and the angle of incidence of measurement light was set at 0 degrees. The transmittance of light in the wavelength range of 380 to 780 nm in the axial direction perpendicular to the transmission axis of the multilayer laminated film (referred to as the reflection axis) was measured at intervals of 5 nm. The reflection axis was determined by crossed Nicols search (650 nm). The average value of the transmittance of light in the wavelength range of 380 to 780 nm in the direction of the reflection axis was defined as the average transmittance. The value obtained by subtracting the average transmittance from 100 was defined as the average reflectance. When the average reflectance was 50% or more, the multilayer laminated film thus measured was determined to be capable of reflecting light. The film was evaluated as A to D based on the average reflectance.
A: 90% or more.
B: 80% or more and less than 90%.
C: 50% or more and less than 80%.
D: Less than 50%.

### Production Example 1: Polyester A

A polyester for birefringent layers was prepared as follows. Dimethyl 2,6-naphthalenedicarboxylate, dimethyl terephthalate, and ethylene glycol were subjected to a transesterification reaction in the presence of titanium tetrabutoxide, and subsequently further subjected to a polycondensation reaction to prepare a copolyester in which 95 mol % of the acid component is a 2,6-naphthalenedicarboxylic acid component, 5 mol % of the acid component was a terephthalic acid component, and the glycol component was an ethylene glycol component (intrinsic viscosity: 0.64 dl/g; measured using o-chlorophenol at 35° C.; this applies to the following).

### Production Example 2: Polyester B

A polyester for isotropic layers was prepared as follows. Dimethyl 2,6-naphthalenedicarboxylate, dimethyl terephthalate, ethylene glycol, and trimethylene glycol were subjected to a transesterification reaction in the presence of titanium tetrabutoxide, and subsequently further subjected to a polycondensation reaction to prepare a copolyester in which 50 mol % of the acid component was a 2,6-naphthalenedicarboxylic acid component, 50 mol % of the acid component was a terephthalic acid component, 85 mol % of the glycol component was an ethylene glycol component, and 15 mol % of the glycol component is a trimethylene glycol component (intrinsic viscosity: 0.63 dl/g).

### Example 1

Polyester A for birefringent layers was dried at 170° C. for 5 hours, and polyester B for isotropic layers was dried at 85° C. for 8 hours. Thereafter, polyester A and polyester B were respectively fed to first and second extruders and heated to 300° C. so that they were in a molten state. The polyester for birefringent layers was divided into 139 layers, and the polyester for isotropic layers was divided into 138 layers. A melt in a laminated state having 277 layers in total was obtained using a multilayer feedblock apparatus equipped with comb teeth for alternately laminating the birefringent layer and the isotropic layer and obtaining the layer thickness profile shown in Table 1. While the laminated state was maintained, the same polyester as the polyester for isotropic layers was introduced to both sides of the melt from a third extruder toward a three-layer feed block to further laminate a buffer layer on both sides in the laminating direction of the melt (both surface layers of which were birefringent layers) in a laminated state having 277 layers. The feed rate of the third extruder was adjusted so that the total of the buffer layers on both sides was 47% of the whole. The laminated state was further divided into two parts using a layer doubling block, and they were laminated at a ratio of 1:1, thereby preparing an unstretched multilayer laminated film having 557 layers in total, including an intermediate layer inside the film and two outermost layers on the outermost surfaces of the film.

The unstretched multilayer laminated film was stretched 5.9-fold in the width direction at a temperature of 130° C. The obtained uniaxially stretched multilayer laminated film had a thickness of 75 pm. The results of refractive index measurement showed that the birefringent layer has birefringent properties and that the isotropic layer has isotropic properties.

### Examples 2 to 15 and Comparative Examples 1 to 5

Multilayer laminated films were obtained in the same manner as in Example 1, except that the multilayer feed block device used was changed so that the layer thickness profiles shown in Table 1 were obtained.

TABLE 1

| | | | | Ex. 1 | Ex. 2 | Ex. 3 | Ex. 4 | Ex. 5 | Ex. 6 | Ex. 7 | Ex. 8 |
|---|---|---|---|---|---|---|---|---|---|---|---|
| Birefringent | Refractive index | nX | — | [symbol] | [symbol] | [symbol] | [symbol] | [symbol] | [symbol] | [symbol] | [symbol] |
| layer | 1st layer in monotonically | Layer thickness | nm | [symbol] | [symbol] | [symbol] | [symbol] | [symbol] | [symbol] | [symbol] | [symbol] |
| | increasing region | Optical thickness | nm | [symbol] | [symbol] | [symbol] | [symbol] | [symbol] | [symbol] | [symbol] | [symbol] |
| | m^{th} layer in monotonically | Layer number | — | [symbol] | [symbol] | [symbol] | [symbol] | [symbol] | [symbol] | [symbol] | [symbol] |
| | increasing region | Layer thickness | nm | [symbol] | [symbol] | [symbol] | [symbol] | [symbol] | [symbol] | [symbol] | [symbol] |
| | | Optical thickness | nm | [symbol] | [symbol] | [symbol] | [symbol] | [symbol] | [symbol] | [symbol] | [symbol] |
| | 0.8 × n^{th} layer in monotonically | Layer number | — | [symbol] | [symbol] | [symbol] | [symbol] | [symbol] | [symbol] | [symbol] | [symbol] |
| | increasing region | Layer thickness | nm | [symbol] | [symbol] | [symbol] | [symbol] | [symbol] | [symbol] | [symbol] | [symbol] |
| | | Optical thickness | nm | [symbol] | [symbol] | [symbol] | [symbol] | [symbol] | [symbol] | [symbol] | [symbol] |
| | Thinnest layer in monotonically | Optical thickness | nm | [symbol] | [symbol] | [symbol] | [symbol] | [symbol] | [symbol] | [symbol] | [symbol] |
| | increasing region | | | | | | | | | | |
| | Thickest layer in monotonically | Optical thickness | nm | [symbol] | [symbol] | [symbol] | [symbol] | [symbol] | [symbol] | [symbol] | [symbol] |
| | increasing region | | | | | | | | | | |
| Isotropic | Refractive index | nX | | [symbol] | [symbol] | [symbol] | [symbol] | [symbol] | [symbol] | [symbol] | [symbol] |
| layer | 1st layer in monotonically | Layer thickness | nm | [symbol] | [symbol] | [symbol] | [symbol] | [symbol] | [symbol] | [symbol] | [symbol] |
| | increasing region | Optical thickness | nm | [symbol] | [symbol] | [symbol] | [symbol] | [symbol] | [symbol] | [symbol] | [symbol] |
| | n^{th} layer in monotonically | Layer number | — | [symbol] | [symbol] | [symbol] | [symbol] | [symbol] | [symbol] | [symbol] | [symbol] |
| | increasing region | Layer thickness | nm | [symbol] | [symbol] | [symbol] | [symbol] | [symbol] | [symbol] | [symbol] | [symbol] |
| | | Optical thickness | nm | [symbol] | [symbol] | [symbol] | [symbol] | [symbol] | [symbol] | [symbol] | [symbol] |
| | 0.8 × n^{th} layer in monotonically | Layer number | — | [symbol] | [symbol] | [symbol] | [symbol] | [symbol] | [symbol] | [symbol] | [symbol] |
| | increasing region | Layer thickness | nm | [symbol] | [symbol] | [symbol] | [symbol] | [symbol] | [symbol] | [symbol] | [symbol] |
| | | Optical thickness | nm | [symbol] | [symbol] | [symbol] | [symbol] | [symbol] | [symbol] | [symbol] | [symbol] |
| | Thinnest layer in monotonically | Optical thickness | nm | [symbol] | [symbol] | [symbol] | [symbol] | [symbol] | [symbol] | [symbol] | [symbol] |
| | increasing region | | | | | | | | | | |
| | Thickest layer in monotonically | Optical thickness | nm | [symbol] | [symbol] | [symbol] | [symbol] | [symbol] | [symbol] | [symbol] | [symbol] |
| | increasing region | | | | | | | | | | |

| | | | | | | | | | |
|---|---|---|---|---|---|---|---|---|---|
| Uneven thickness | % | [symbol] | [symbol] | [symbol] | [symbol] | [symbol] | [symbol] | [symbol] | [symbol] |
| Capable of reflecting light | — | Yes | Yes | Yes | Yes | Yes | Yes | Yes | Yes |
| Average reflectance (380 to 780 nm) | % | A | A | A | B | A | A | A | B |
| Color unevenness evaluation | — | A | [symbol] | C | D | [symbol] | C | [symbol] | D |

| | | | | Ex. 9 | Ex. 10 | Ex. 11 | Ex. 12 | Ex. 13 | Ex. 14 | Ex. 15 |
|---|---|---|---|---|---|---|---|---|---|---|
| Birefringent | Refractive index | nX | — | [symbol] | [symbol] | [symbol] | [symbol] | [symbol] | [symbol] | [symbol] |
| layer | 1st layer in monotonically | Layer thickness | nm | [symbol] | [symbol] | [symbol] | [symbol] | [symbol] | [symbol] | [symbol] |
| | increasing region | Optical thickness | nm | [symbol] | [symbol] | [symbol] | [symbol] | [symbol] | [symbol] | [symbol] |
| | m^{th} layer in monotonically | Layer number | — | [symbol] | [symbol] | [symbol] | [symbol] | [symbol] | [symbol] | [symbol] |
| | increasing region | Layer thickness | nm | [symbol] | [symbol] | [symbol] | [symbol] | [symbol] | [symbol] | [symbol] |
| | | Optical thickness | nm | [symbol] | [symbol] | [symbol] | [symbol] | [symbol] | [symbol] | [symbol] |
| | 0.8 × n^{th} layer in monotonically | Layer number | — | [symbol] | [symbol] | [symbol] | [symbol] | [symbol] | [symbol] | [symbol] |
| | increasing region | Layer thickness | nm | [symbol] | [symbol] | [symbol] | [symbol] | [symbol] | [symbol] | [symbol] |
| | | Optical thickness | nm | [symbol] | [symbol] | [symbol] | [symbol] | [symbol] | [symbol] | [symbol] |
| | Thinnest layer in monotonically | Optical thickness | nm | [symbol] | [symbol] | [symbol] | [symbol] | [symbol] | [symbol] | [symbol] |
| | increasing region | | | | | | | | | |
| | Thickest layer in monotonically | Optical thickness | nm | [symbol] | [symbol] | [symbol] | [symbol] | [symbol] | [symbol] | [symbol] |
| | increasing region | | | | | | | | | |
| Isotropic | Refractive index | nX | | [symbol] | [symbol] | [symbol] | [symbol] | [symbol] | [symbol] | [symbol] |
| layer | 1st layer in monotonically | Layer thickness | nm | [symbol] | [symbol] | [symbol] | [symbol] | [symbol] | [symbol] | [symbol] |
| | increasing region | Optical thickness | nm | [symbol] | [symbol] | [symbol] | [symbol] | [symbol] | [symbol] | [symbol] |
| | n^{th} layer in monotonically | Layer number | — | [symbol] | [symbol] | [symbol] | [symbol] | [symbol] | [symbol] | [symbol] |
| | increasing region | Layer thickness | nm | [symbol] | [symbol] | [symbol] | [symbol] | [symbol] | [symbol] | [symbol] |
| | | Optical thickness | nm | [symbol] | [symbol] | [symbol] | [symbol] | [symbol] | [symbol] | [symbol] |
| | 0.8 × n^{th} layer in monotonically | Layer number | — | [symbol] | [symbol] | [symbol] | [symbol] | [symbol] | [symbol] | [symbol] |
| | increasing region | Layer thickness | nm | [symbol] | [symbol] | [symbol] | [symbol] | [symbol] | [symbol] | [symbol] |
| | | Optical thickness | nm | [symbol] | [symbol] | [symbol] | [symbol] | [symbol] | [symbol] | [symbol] |
| | Thinnest layer in monotonically | Optical thickness | nm | [symbol] | [symbol] | [symbol] | [symbol] | [symbol] | [symbol] | [symbol] |
| | increasing region | | | | | | | | | |
| | Thickest layer in monotonically | Optical thickness | nm | [symbol] | [symbol] | [symbol] | [symbol] | [symbol] | [symbol] | [symbol] |
| | increasing region | | | | | | | | | |

| | | | | | | | | |
|---|---|---|---|---|---|---|---|---|
| Uneven thickness | % | [symbol] | [symbol] | [symbol] | [symbol] | [symbol] | [symbol] | [symbol] |
| Capable of reflecting light | — | Yes | Yes | Yes | Yes | Yes | Yes | Yes |
| Average reflectance (380 to 780 nm) | % | B | A | B | A | A | A | A |
| Color unevenness evaluation | — | D | D | D | B | B | B | B |

| | | | | Comp. | Comp. | Comp. | Comp. | Comp. |
|---|---|---|---|---|---|---|---|---|
| | | | | Ex. 1 | Ex. 2 | Ex. 3 | Ex. 4 | Ex. 5 |
| Birefringent | Refractive index | nX | — | [symbol] | [symbol] | [symbol] | [symbol] | [symbol] |
| layer | 1st layer in monotonically | Layer thickness | nm | [symbol] | [symbol] | [symbol] | [symbol] | [symbol] |
| | increasing region | Optical thickness | nm | [symbol] | [symbol] | [symbol] | [symbol] | [symbol] |
| | m^{th} layer in monotonically | Layer number | — | [symbol] | [symbol] | [symbol] | [symbol] | [symbol] |
| | increasing region | Layer thickness | nm | [symbol] | [symbol] | [symbol] | [symbol] | [symbol] |
| | | Optical thickness | nm | [symbol] | [symbol] | [symbol] | [symbol] | [symbol] |
| | 0.8 × n^{th} layer in monotonically | Layer number | — | [symbol] | [symbol] | [symbol] | [symbol] | [symbol] |
| | increasing region | Layer thickness | nm | [symbol] | [symbol] | [symbol] | [symbol] | [symbol] |
| | | Optical thickness | nm | [symbol] | [symbol] | [symbol] | [symbol] | [symbol] |
| | Thinnest layer in monotonically | Optical thickness | nm | [symbol] | [symbol] | [symbol] | [symbol] | [symbol] |
| | increasing region | | | | | | | |
| | Thickest layer in monotonically | Optical thickness | nm | [symbol] | [symbol] | [symbol] | [symbol] | [symbol] |
| | increasing region | | | | | | | |
| Isotropic | Refractive index | nX | | [symbol] | [symbol] | [symbol] | [symbol] | [symbol] |
| layer | 1st layer in monotonically | Layer thickness | nm | [symbol] | [symbol] | [symbol] | [symbol] | [symbol] |
| | increasing region | Optical thickness | nm | [symbol] | [symbol] | [symbol] | [symbol] | [symbol] |
| | n^{th} layer in monotonically | Layer number | — | [symbol] | [symbol] | [symbol] | [symbol] | [symbol] |
| | increasing region | Layer thickness | nm | [symbol] | [symbol] | [symbol] | [symbol] | [symbol] |
| | | Optical thickness | nm | [symbol] | [symbol] | [symbol] | [symbol] | [symbol] |
| | 0.8 × n^{th} layer in monotonically | Layer number | — | [symbol] | [symbol] | [symbol] | [symbol] | [symbol] |
| | increasing region | Layer thickness | nm | [symbol] | [symbol] | [symbol] | [symbol] | [symbol] |
| | | Optical thickness | nm | [symbol] | [symbol] | [symbol] | [symbol] | [symbol] |
| | Thinnest layer in monotonically | Optical thickness | nm | [symbol] | [symbol] | [symbol] | [symbol] | [symbol] |
| | increasing region | | | | | | | |
| | Thickest layer in monotonically | Optical thickness | nm | [symbol] | [symbol] | [symbol] | [symbol] | [symbol] |
| | increasing region | | | | | | | |

| | | | | | | |
|---|---|---|---|---|---|---|
| Uneven thickness | % | [symbol] | [symbol] | [symbol] | [symbol] | [symbol] |
| Capable of reflecting light | — | Yes | Yes | Yes | Yes | Yes |
| Average reflectance (380 to 780 nm) | % | A | A | A | B | A |
| Color unevenness evaluation | — | E | E | E | E | E |

[symbol]

indicates data missing or illegible when filed

### INDUSTRIAL APPLICABILITY

The multilayer laminated film according to one embodiment of the present invention enables color unevenness due to uneven thickness to be less visible and exhibits a higher reflectance over a broad wavelength range by appropriately designing the optical thickness of a birefringent layer and an isotropic layer that are alternately laminated. Accordingly, when the film is used as a luminance-improving member, a reflective polarizer, or the like, for which polarization performance is required, the film exhibits a high degree of polarization, with color unevenness being invisible. Therefore, more highly reliable luminance-improving members, polarizers for liquid crystal displays, and the like can be provided.

The disclosure of Japan Patent Application No. 2018-029797 filed on Feb. 22, 2018, is incorporated herein by reference in its entirety.

All of the documents, patent applications, and technical standards referred to in the present specification are incorporated herein by reference to the same extent in which these individual documents, patent applications, and technical standards were specifically and individually indicated to be incorporated by reference.

1. A multilayer laminated film comprising a multilayer laminate in which a birefringent layer comprising a first resin and an isotropic layer comprising a second resin are alternately laminated,
the multilayer laminated film being capable of reflecting light at a wavelength of 380 to 780 nm due to optical interference caused from the lamination structure of the birefringent layer and the isotropic layer,
a series of the birefringent layers having an optical thickness monotonically increasing region (first monotonically increasing region), wherein when the thinnest layer that has an optical thickness of 100 nm or more in the first monotonically increasing region is defined as the 1^{st} layer and the thickest layer that has an optical thickness of 190 nm or less in the first monotonically increasing region is defined as an m^{th} layer, the 0.8×m^{th} layer (if 0.8×m is not an integer, the ordinal of the rounded-off integer of 0.8×m) has an optical thickness in the range of 140 to 180 nm,
a series of the isotropic layers having an optical thickness monotonically increasing region (second monotonically increasing region), wherein when the thinnest layer that has an optical thickness of 120 nm or more in the second monotonically increasing region is defined as the 1^{st} layer and the thickest layer that has an optical thickness of 350 nm or less in the second monotonically increasing region is defined as an n^{th} layer, the 0.8×n^{th} layer (if 0.8×n is not an integer, the ordinal of the rounded-off integer of 0.8×n) has an optical thickness in the range of 150 to 280 nm.

2. A luminance-improving member comprising the multilayer laminated film of claim 1.

3. A polarizer for a liquid crystal display, the polarizer comprising the multilayer laminated film of claim 1.
